(19) United States
(12) Patent Application Publication
(10) Pub. No.: US 2026/0025196 A1
(43) Pub. Date: Jan. 22, 2026

(54) METHOD, SYSTEM AND STORAGE MEDIUM OF NEQUICK-G BASED IONOSPHERE ESTIMATION USING CONSTRAINED UNSCENTED KALMAN FILTER

(71) Applicant: Intelligent Fusion Technology, Inc., Germantown, MD (US)

(72) Inventors: Dan SHEN, Germantown, MD (US); Genshe CHEN, Germantown, MD (US); Khanh PHAM, Albuquerque, NM (US)

(21) Appl. No.: 18/774,654

(22) Filed: Jul. 16, 2024

(51) Int. Cl. H04B 7/185

(52) U.S. Cl. CPC H04B 7/18519

(57) ABSTRACT

The present disclosure provides an ionosphere estimation method applied to a single satellite, an ionosphere estimation system, and a storage medium. The method includes providing locations of the single satellite and an enhanced reference emitter (ERE); using the locations of the single satellite and the ERE to obtain a measured ionospheric delay and transmitting the measured ionospheric delay to the ERE; determining a measured STEC using the measured ionospheric delay; and updating a NeQuick-G model deployed in one or more of the plurality of EREs by implementing a cUKF. Updating the NeQuick-G model includes inputting a plurality of ionospheric coefficients estimated by cUKF to the NeQuick-G model; calculating an effective ionization level using the plurality of ionospheric coefficients; using the effective ionization level to obtain an estimated STEC; calculating updated ionospheric coefficients using the estimated STEC and the measured STEC; and updating the NeQuick-G model using the updated ionospheric coefficients.

### GOVERNMENT RIGHTS

The present disclosure was made with Government support under Contracts No. FA9453-22-C-A106 and No. FA9453-22-C-A127, awarded by the United States Air Force Research Laboratory. The U.S. Government has certain rights in the present disclosure.

### FIELD OF THE DISCLOSURE

The present disclosure generally relates to the field of satellite communication technology and, more particularly, relates to an ionosphere estimation applied to a single satellite, an ionosphere estimation system, and a storage medium.

### BACKGROUND

Interference of satellite communications is a frequent and ongoing concern for both DoD (department of defense) and civilian enterprises. Satellite communications face increasingly diverse physical and electromagnetic interference (EMI) that transmits radio frequency (RF) signals in X/Ku/K/Ka/Q-bands. Therefore, RF emitter detection and localization is a key enabler for reliable space control, space situational awareness, intelligence surveillance and reconnaissance, as well as satellite communications together with positioning, navigation and timing. Geolocation of an interfering source is an essential step in mitigating or eliminating the interference and restoring operation of the communication services. The DDDAS (dynamic data driven applications systems) program (which combines theoretical simulations with real-time data monitoring) looked into variations of ionospheric models in support of SSA (space situational awareness) drag, as highlighted by DDDAS methods.

Ionospheric delay significantly affects accuracy of positioning applications, posing a challenge due to nonhomogeneous electron densities and magnetic fields that characterize the global ionosphere. Ionospheric correction models aimed at effectively mitigating ionospheric delay have been recently introduced. One of the ionospheric correction models is NeQuick, which offers a comprehensive 3-D representation of electron density over time, as well as the longitudes, latitudes, and heights of both a satellite transmitter (emitter) and a ground receiver. NeQuick finds extensive application in various fields, including Global Navigation Satellite Systems (GNSS) navigation, radio communication, and space weather research. The latest iteration NeQuick-G is an adaptation that caters to real-time users, utilizing the International Telecommunication Union (ITU)-R NeQuick ionospheric electron density model. NeQuick-G relies on three ionospheric coefficients, which are transmitted by Galileo Satellites. These coefficients are optimized for all Galileo sensor stations worldwide, making the coefficients less than optimal for local users. Additionally, the coefficient updates are not in real time (not immediate update).

### BRIEF SUMMARY OF THE DISCLOSURE

One aspect of the present disclosure provides an ionosphere estimation method applied to a single satellite. The method includes providing locations of the single satellite and an enhanced reference emitter (ERE) of a plurality of EREs by the single satellite; using the locations of the single satellite and the ERE to obtain a measured ionospheric delay and transmitting the measured ionospheric delay to the ERE by the single satellite; determining a measured slant total electron content (STEC) using the measured ionospheric delay; and updating a NeQuick-G model deployed in one or more of the plurality of EREs by implementing a constrained unscented Kalman filter (cUKF). Updating the NeQuick-G model includes inputting a plurality of ionospheric coefficients estimated by cUKF to the NeQuick-G model; calculating an effective ionization level using the plurality of ionospheric coefficients; using the effective ionization level to obtain an estimated STEC; calculating updated ionospheric coefficients using the estimated STEC and the measured STEC; and updating the NeQuick-G model using the updated ionospheric coefficients.

Another aspect of the present disclosure provides an ionosphere estimation system. The system includes a memory, configured to store program instructions for performing an ionosphere estimation method applied to a single satellite; and a processor, coupled with the memory and, when executing the program instructions, configured for: providing locations of the single satellite and an enhanced reference emitter (ERE) of a plurality of EREs by the single satellite; using the locations of the single satellite and the ERE to obtain a measured ionospheric delay and transmitting the measured ionospheric delay to the ERE by the single satellite; determining a measured slant total electron content (STEC) using the measured ionospheric delay; and updating a NeQuick-G model deployed in one or more of the plurality of EREs by implementing a constrained unscented Kalman filter (cUKF). Updating the NeQuick-G model includes inputting a plurality of ionospheric coefficients estimated by cUKF to the NeQuick-G model; calculating an effective ionization level using the plurality of ionospheric coefficients; using the effective ionization level to obtain an estimated STEC; calculating updated ionospheric coefficients using the estimated STEC and the measured STEC; and updating the NeQuick-G model using the updated ionospheric coefficients.

Another aspect of the present disclosure provides a non-transitory computer-readable storage medium, containing program instructions for, when being executed by a processor, performing an ionosphere estimation method applied to a single satellite. The method includes providing locations of the single satellite and an enhanced reference emitter (ERE) of a plurality of EREs by the single satellite; using the locations of the single satellite and the ERE to obtain a measured ionospheric delay and transmitting the measured ionospheric delay to the ERE by the single satellite; determining a measured slant total electron content (STEC) using the measured ionospheric delay; and updating a NeQuick-G model deployed in one or more of the plurality of EREs by implementing a constrained unscented Kalman filter (cUKF). Updating the NeQuick-G model includes inputting a plurality of ionospheric coefficients estimated by cUKF to the NeQuick-G model; calculating an effective ionization level using the plurality of ionospheric coefficients; using the effective ionization level to obtain an estimated STEC; calculating updated ionospheric coefficients using the estimated STEC and the measured STEC; and updating the NeQuick-G model using the updated ionospheric coefficients.

Other aspects of the present disclosure may be understood by those skilled in the art in light of the description, the claims, and the drawings of the present disclosure.

### BRIEF DESCRIPTION OF THE DRAWINGS

The accompanying drawings, which are incorporated into a part of the specification, illustrate embodiments of the present disclosure and together with the description to explain the principles of the present disclosure.

FIG. 1 depicts an exemplary ionosphere estimation method applied to a signal satellite according to various disclosed embodiments of the present disclosure.

FIG. 2 depicts a schematic of an exemplary NeQuick-G model according to various disclosed embodiments of the present disclosure.

FIG. 3 depicts a schematic of improvements of a NeQuick-G based ionosphere estimation method according to various disclosed embodiments of the present disclosure.

FIG. 4 depicts concept of operations (CONOPS) of a constrained unscented Kalman filter (cUKF) for a locally optimized NeQuick-G model according to various disclosed embodiments of the present disclosure.

FIG. 5 depicts an exemplary scenario with a low earth orbit (LEO) satellite, an electromagnetic interference (EMI) emitter and four enhanced reference emitters (EREs) according to various disclosed embodiments of the present disclosure.

FIG. 6A depicts an exemplary schematic of an estimated ionospheric coefficient (a0) from a constrained unscented Kalman filter (cUKF) according to various disclosed embodiments of the present disclosure.

FIG. 6B depicts an exemplary schematic of an estimated ionospheric coefficient (a1) from a constrained unscented Kalman filter (cUKF) according to various disclosed embodiments of the present disclosure.

FIG. 6C depicts an exemplary schematic of an estimated ionospheric coefficient (a2) from a constrained unscented Kalman filter (cUKF) according to various disclosed embodiments of the present disclosure.

FIG. 7 depicts an exemplary schematic of comparison of measured STEC and estimated STEC for four enhanced reference emitters (EREs) according to various disclosed embodiments of the present disclosure.

### DETAILED DESCRIPTION

References may be made in detail to exemplary embodiments of the disclosure, which may be illustrated in the accompanying drawings. Wherever possible, same reference numbers may be used throughout the accompanying drawings to refer to same or similar parts.

Ionospheric delay is one of the dominant sources deteriorating the accuracy of positioning applications. Since the ionosphere is characterized by nonhomogeneous electron densities and magnetic fields on the global scale, real-time ionospheric correction models are configured to effectively eliminate the ionospheric delay. In these models, vertical total electron content (VTEC) is updated routinely; and slant total electron content (STEC) and corresponding range delay are estimated (calculated) by thin-shell approximation in multiplication with an elevation-dependent mapping function. However, the thin-layer approximation is no longer valid if the electron density profile fluctuates dramatically along the altitude. Such limitation may be overcome by a NeQuick model, which may provide a real-time 3-D description of electron density as a function of time and the longitudes, latitudes, and heights of both a satellite transmitter and a ground receiver.

The first version of the NeQuick model, referred to as NeQuick 1, has been adopted by the ITU radiocommunication sector as a procedure for estimating TEC. Subsequently, NeQuick 1 is refined as NeQuick 2 which is currently recommended by ITU and also included in the space environment information system (SPENVIS) by the European Space Agency (ESA). More recently, the NeQuick model has been adapted to a Galileo specific model, referred to as NeQuick-G, which is demonstrated to be able to perform ionospheric correction of single-frequency observations from spaceborne applications.

The NeQuick-G model relies on three ionospheric coefficients, which are transmitted by Galileo Satellites. These coefficients are optimized for all Galileo sensor stations worldwide, making the coefficients less than optimal for local users. Additionally, the coefficient updates are not in real time (not immediate update). To address these limitations, an unscented Kalman filter (UKF) for tracking three ionospheric coefficients is implemented, which is achieved by utilizing multiple (e.g., four) local reference emitters and one low earth orbit (LEO) satellite, with the objective of passively geolocating ground-based EMI sources. The accurate and real-time estimation of the ionosphere provided by the UKF and NeQuick may significantly enhance geolocation accuracy.

According to various embodiments of the present disclosure, a method, a system, and a storage medium for NeQuick-G based ionosphere estimation using a constrained unscented Kalman filter (cUKF) are described hereinafter.

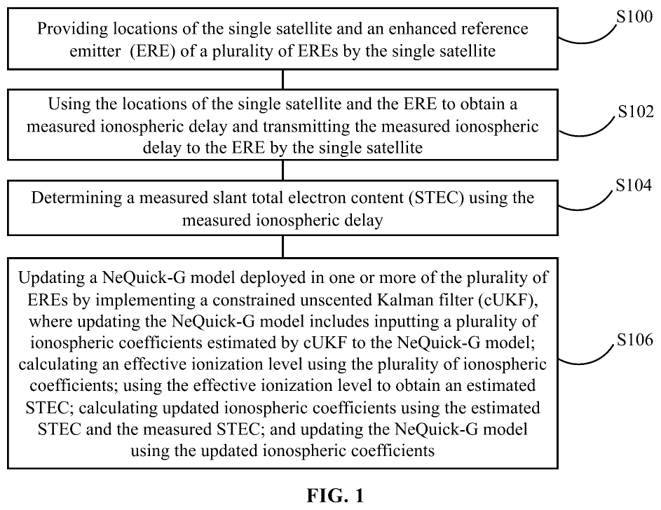

FIG. 1 depicts an exemplary NeQuick-G based ionosphere estimation method using cUKF according to various disclosed embodiments of the present disclosure. Referring to FIG. 1, the NeQuick-G based ionosphere estimation method using cUKF may include following exemplary steps.

In S100, locations of the single satellite and an enhanced reference emitter (ERE) of a plurality of EREs are provided by the single satellite.

In S102, the locations of the single satellite and the ERE are configured to obtain a measured ionospheric delay, and the measured ionospheric delay is transmitted to the ERE by the single satellite.

In S104, a measured slant total electron content (STEC) is determined using the measured ionospheric delay.

In S106, a NeQuick-G model deployed in one or more of the plurality of EREs is updated by implementing cUKF. Updating the NeQuick-G model includes inputting a plurality of ionospheric coefficients estimated by cUKF to the NeQuick-G model; calculating an effective ionization level using the plurality of ionospheric coefficients; using the effective ionization level to obtain an estimated STEC; calculating updated ionospheric coefficients using the estimated STEC and the measured STEC; and updating the NeQuick-G model using the updated ionospheric coefficients.

Optionally, in some embodiments, all of the plurality of EREs may be together configured to update the NeQuick-G model; and the measurements (for example, measured ionospheric delays) of all of the plurality of EREs may be stacked up as a measurement vector.

In one embodiment, the ionosphere estimation method further includes using the updated NeQuick-G model to estimate ionospheric delay along a path between the single satellite and an electromagnetic interference (EMI) source.

Optionally, in some embodiments, the EREs may send data including time stamps and corresponding locations to the satellite; and then the satellite may run the cUKF.

In one embodiment, implementing the cUKF includes calculating sigma points in the cUKF using previous projected state estimates; projecting a part of the sigma points which are not in a constrained solution space into a feasible region to obtain projected sigma points; running the projected sigma points through time update equations to obtain time-projected sigma points and to obtain a time update; projecting state estimates which are not in the constrained solution space into the feasible region to obtain projected state estimates; and running the time-projected sigma points through measurement update equations to obtain a measurement update, where the measurement update includes the plurality of ionospheric coefficients.

In one embodiment, determining the measured STEC using the measured ionospheric delay is defined as:

$$S TEC = {I}_{f} / {α}_{f}$$

where I_{f} denotes the measured ionospheric delay, f denotes a frequency of an electromagnetic wave, and

$${α}_{f} = \frac{4 0.3 \times {10}^{16}}{{f}^{2}} .$$

In one embodiment, a constraint of the cUKF is defined by the effective ionization level equal to or less than 400 solar flux units.

In one embodiment, the plurality of ionospheric coefficients are constant during a tracking period.

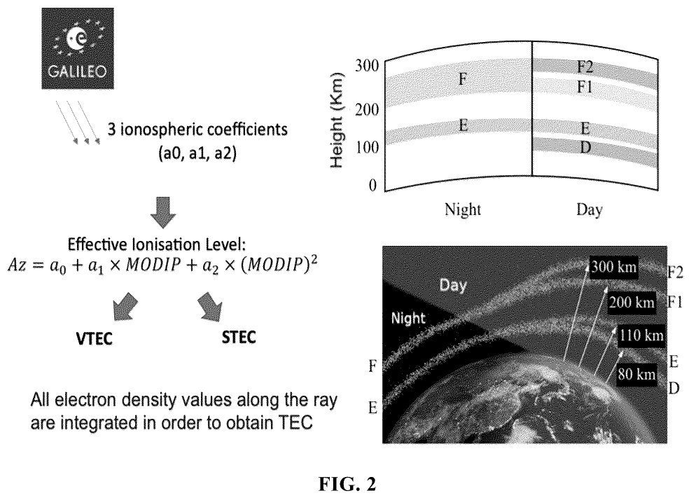

According to various embodiments of the present disclosure, the NeQuick-G model is described hereinafter. FIG. 2 depicts a schematic of an exemplary NeQuick-G model according to various disclosed embodiments of the present disclosure. Unlike the NeQuick 1 model and the NeQuick 2 model where the solar activity/solar flux are characterized by R12 (the 12-month average sunspot number) or F10.7 (solar radio flux at 10.7 cm wavelength), the NeQuick-G model may use the effective ionization level Az calculated as the following:

$$A z = {a}_{0} + {a}_{1} μ + {a}_{2} {μ}^{2} \qquad ( 1 )$$

where μ denotes a receiver's modified dip (MODIP) in degree, which is related to the geographic latitude and magnetic field at the receiver; and parameters a₀, a₁ and a₂ denote three ionospheric coefficients which are broadcasted as a part of a navigation message. The NeQuick-G model may determine the MODIP value by interpolation of tabulated global grid of longitude/latitude points.

Referring to FIG. 2, when a sky wave leaves the Earth's surface and travels upwards, the first region of interest that it reaches in the ionosphere is called the D region (layer). Also referring to FIG. 2, the E region (layer) is above the D region (layer) and exists at altitudes between about 100 and 125 kilometers. Instead of attenuating radio communications signals, the E region mainly refracts signals to a degree where the signals are returned to earth. As such the signals appear to have been reflected by the E region. However, the E region still acts as an attenuator to a certain degree. Also referring to FIG. 2, the most important region in the ionosphere for long distance HF radio communications is the F region. During the daytime when radiation is being received from the Sun, the F region often splits into two regions including the lower one being the F1 region and the higher one being the F2 region. The F1 region is more of an inflection point in the electron density curve and normally only exists in the summer.

Based on calculated Az values, the NeQuick-G model may determine the STEC or VTEC values from the numerical integral ∫ₚₐₜₕ N d [symbol] , where N denotes an electron density, along a propagation path l between a satellite transmitter and a ground receiver. The propagation path may pass various ionospheric layers as shown in FIG. 2. Different layers may have different parameters values to compute N.

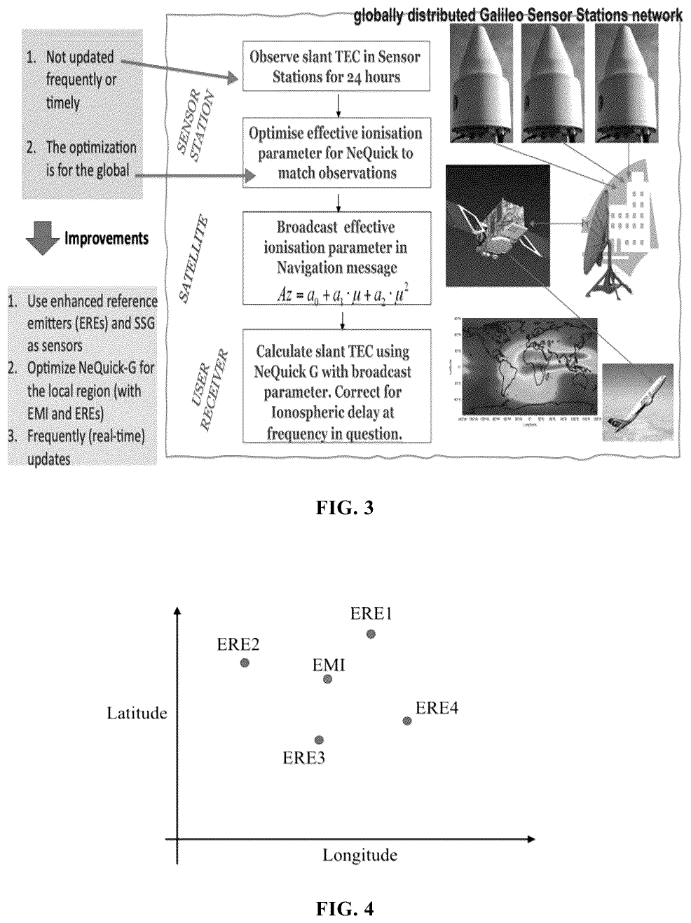

The NeQuick-G model may rely on three ionospheric coefficients, which are transmitted by Galileo Satellites. These coefficients are optimized for all Galileo sensor stations worldwide, such that the coefficients may be less than optimal for local users. Additionally, the coefficient updates may be not frequently. FIG. 3 depicts a schematic of improvements of a NeQuick-G based ionosphere estimation method using cUKF according to various disclosed embodiments of the present disclosure.

According to various embodiments of the present disclosure, cUKF for NeQuick-G is described in detail hereinafter.

A general nonlinear filtering problem may be defined as the following:

$${x}_{k + 1} = {f}_{k} ( {x}_{k} , {w}_{k} ) \qquad ( 2 )$$

$${z}_{k} = {h}_{k} ( {x}_{k} , {v}_{k} ) \qquad ( 3 )$$

$$0 = {g}_{k} ( {x}_{k} ) \qquad ( 4 )$$

where xₖ denotes a state vector (L×1) at a time instant k; zₖ denotes a measurement vector (N×1) at the time instant k; fₖ and hₖ denote nonlinear functions; wₖ and vₖ denote independent white noise processes of state and measurement equations, with zero mean and covariances Qₖ and Vₖ, respectively; L denotes a state dimension; N denotes a measurement dimension; and gₖ denotes constraints of a system.

For the Kalman filter, it is assumed that f (process) and h (measurement) are linear. The state variables may be Gaussian random variables (GRVs). It should be noted that a GRV putting through a linear system is still a GRV, so that the Kalman filter may be optimal for linear systems. For a nonlinear system, characterizing resulting distribution of propagated GRVs may be non-trivial. For UKF, resulting distribution may be represented by a set of 2L+1 deterministic sample points which are called sigma points.

In the NeQuick-G tracking of the present disclosure, the state xₖ is the ionospheric coefficients (a₀, a₁ and a₂). For the feasibility, it is assumed the ionospheric coefficients are constants during the tracking period (˜500 seconds), xₖ₊₁=xₖ. hₖ is the NeQuick-G model of the STEC. gₖ is the condition such that xₖ should satisfy A_{z}≤400 as specified.

In the present disclosure, the constrained UKF (cUKF) may be used based on the following observations. cUKF may be ideally suited for dealing with the nonlinear in the NeQuick-G measurement model. The cUKF may provide increased modeling capabilities and robustness compared to the nonlinear least squares (NLLS) and extended Kalman filter (EKF) approaches. cUKF may maintain fast computation capabilities and may not need the large number of samples that are required for the particle filter (PF) to map nonlinear measurements. Adding the A_{z}≤400 bound constraint may provide fast convergence and greatly increase the search area and accuracy with straightforward implementation within the UKF framework.

According to various embodiments of the present disclosure, the Ne-Quick G model (i.e., the measurement model) is described in detail hereinafter.

Given locations of ground transmitters (enhanced refence emitters, EREs) and a single satellite for EMI geolocation (SSG), the Ne-Quick G model may map the states, that is, ionospheric coefficients (a₀, a₁ and a₂), to the ionospheric density values in STEC or VTEC.

The ionospheric density may be measured in real-time using ERE and SSG via the ionospheric delay I_{f} (at a frequency f) as the following:

$${I}_{f} = {α}_{f} \times S T E C \qquad ( 5 )$$

where the values of STEC are in the unit of total electron content unit (TECU), and 1 TECU=1016 electrons/m2.

$${α}_{f} = \frac{40.3 \times 1 {0}^{16}}{{f}^{2}} \qquad ( 6 )$$

The sigma points in the cUKF may be calculated as the following:

$${χ}_{0} = {\overline{x}}_{k - 1} \qquad ( 7 )$$

$${χ}_{i} = {\overline{x}}_{k - 1} + {ϛ ( \sqrt{{P}_{{x}_{k - 1}}} )}_{i} , for i = 1 , … , L \qquad ( 8 )$$

$${χ}_{i} = {\overline{x}}_{k - 1} - {ϛ ( \sqrt{{P}_{{x}_{k - 1}}} )}_{i} , for i = L + 1 , … , 2 L \qquad ( 9 )$$

where ç denotes a scaling factor that determines the spread of the sigma points relative to corresponding mean, x̅ₖ₋₁ denotes sample average at time instant k−1, and Pₓ_{_{k−1}} denotes state covariance at time instant k−1. These sigma points may be then fed through the state and measurement equations, and resulting distributions may be approximated with weighted sample means and weighted sample covariances.

The time update equations may be described as follows:

$${χ}_{k / t}^{x} = f ( {χ}_{t}^{x} , {χ}_{t}^{w} ) \qquad ( 10 )$$

$${\hat{x}}_{k}^{-} = {\sum }_{i = 0}^{2 L} {w}_{i}^{m} {χ}_{k / ti}^{x} \qquad ( 11 )$$

$$\hat{P} {}_{{x}_{k}}^{\_} = {\sum }_{i = 0}^{2 L} {w}_{i}^{c} ( {χ}_{k / ti}^{x} - {\hat{x}}_{k}^{-} ) {( {χ}_{k / ti}^{x} - {\hat{x}}_{k}^{-} )}^{⊤} + {Q}_{k} \qquad ( 12 )$$

where

$${X}_{t}^{x}$$

denotes the sigma point for state at time index t;

$${X}_{t}^{w}$$

denotes the sigma point for noise at time index t for the time update equations;

$${\hat{x}}_{k}^{-}$$

denotes estimated average state;

$${\hat{P}}_{{x}_{k}}^{-}$$

denotes estimated average state covariance; [symbol] denotes an operator; i denotes an index of a sigma point;

$${w}_{i}^{m} = {w}_{i}^{c} = \frac{1}{2 ( L + λ )} ;$$

and Qₖ denotes the covariance of process noise.

The measurement update equations may be described as follows:

$${χ}_{k / t}^{z} = h ( {χ}_{t}^{x} , {χ}_{t}^{v} ) \qquad ( 13 )$$

$${\hat{z}}_{k}^{-} = {\sum }_{i = 0}^{2 L} {w}_{i}^{m} {χ}_{k / ti}^{z} \qquad ( 14 )$$

$$\hat{P} {}_{{z}_{k}}^{\_} = {\sum }_{i = 0}^{2 L} {w}_{i}^{c} ( {χ}_{k / ti}^{z} - {\hat{z}}_{k}^{-} ) {( {χ}_{k / ti}^{z} - {\hat{z}}_{k}^{-} )}^{⊤} + {R}_{k} \qquad ( 15 )$$

$$\hat{P} {}_{{x}_{k} {z}_{k}}^{\_} = {\sum }_{i = 0}^{2 L} {w}_{i}^{c} ( {χ}_{k / ti}^{x} - {\hat{x}}_{k}^{-} ) {( {χ}_{k / ti}^{z} - {\hat{z}}_{k}^{-} )}^{⊤} \qquad ( 16 )$$

where

$${X}_{t}^{v}$$

denotes the sigma point tor noise at time index t for the measurement update equations;

$${\hat{z}}_{k}^{-}$$

denotes estimated average measurement;

$${\hat{P}}_{{z}_{k}}^{-}$$

denotes estimates average measurement covariance; the weights are specified as

$${w}_{0}^{m} = \frac{λ}{L + λ} , {w}_{0}^{c} = \frac{λ}{L + λ} + ( 1 - {α}^{2} + β ) , and$$

$${w}_{i}^{m} = {w}_{i}^{c} = \frac{1}{2 ( L + λ )}$$

for i=1, 2 . . . 2L; Rₖ denotes the covariance of the measurement noises; and α, β, and λ may be configured to taper the spread of the sigma points relative to prior mean.

The main steps of performing cUKF for NeQuick-G are described as the following: 1) sigma points may be calculated according to the initial conditions; 2) sigma points that are not in the constrained solution space may be projected into the feasible region to obtain projected sigma points; 3) projected sigma points may be run through the time update equations; 4) the state estimates outside the constrained solution space may be projected into the feasible region using the same algorithm in step 2; and 5) projected sigma points may be run through measurement-update equations.

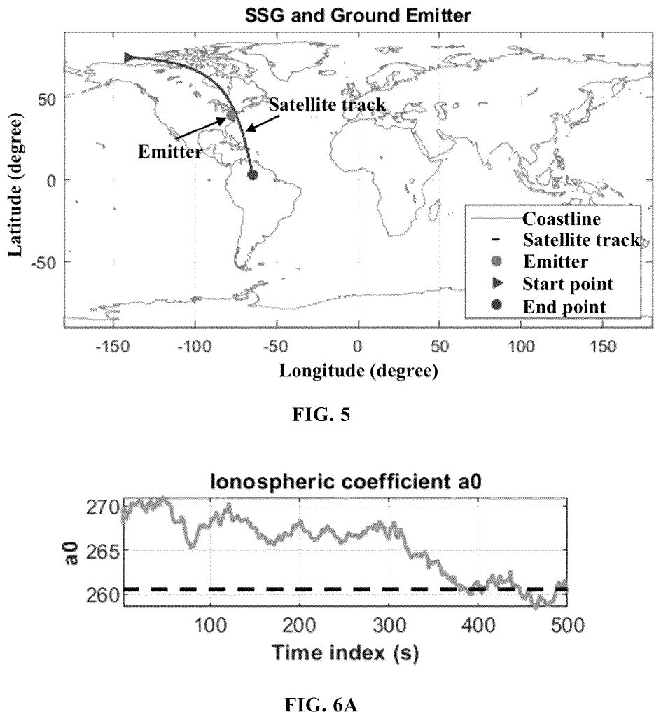

The concept of operations (CONOPS) of demonstrating the cUKF for locally optimized NeQuick-G are summarized in FIG. 4. FIG. 4 depicts concept of operations (CONOPS) of cUKF for a locally optimized NeQuick-G model according to various disclosed embodiments of the present disclosure. FIG. 5 depicts an exemplary scenario with a low earth orbit (LEO) satellite, an electromagnetic interference (EMI) emitter and four enhanced reference emitters (EREs) according to various disclosed embodiments of the present disclosure. Referring to FIG. 4, cUKF filtering technique may be configured to estimate a₀, a₁ and a₂. Ionospheric delay measured by an ERE may be equal to C×Δt−distance (satellite, ERE), where C denotes the speed of light, Δt denotes a time difference between the satellite and ERE, and distance (satellite, ERE) denotes a distance between the satellite and ERE. The advantages of locally optimized model may include timely and frequent updates, desirable local optimization and the like.

Referring to FIG. 4, the orbit of the LEO satellite may be propagated using SGP4 and a two-line-elements (TLE) file from space-track.org.

Exemplarily, the satellite TLE may be shown as the following:
1 04139U 00000 16171.89568986.00000098 00000-0 25282-4 0 06
2 04139 74.0342 79.1740 0007229 258.8779 101.1575 14.62696590047575

Exemplarily, the EMI emitter location including Latitude, longitude, and altitude (LLA) may be shown as the following: Emitter_LLA=[39.18644159, −77.24952161, 10].

Exemplarily, locations (LLA) of EREs may be shown as the following:

$$ERE 1 = EMI + [ 0 \text{.9} , 0.1 , 0 ] ;$$

$$ERE 2 = EMI + [ - 0.1 , 0.9 , 0 ] ;$$

$$EERE 3 = EMI + [ - 0 \text{.9} , - 0.1 , 0 ] ; and$$

$$ERE 4 = EMI + [ 0 \text{.1} , - 0.9 , 0 ] .$$

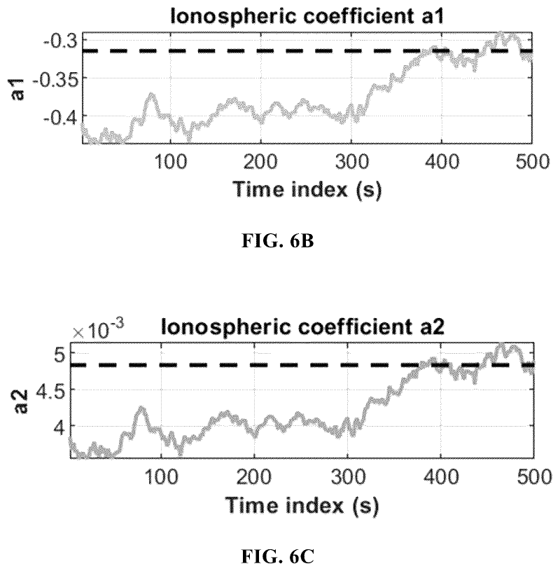

The estimated (calculated or tracked) ionospheric coefficients are shown in FIGS. 6A-6C, where the black dashed lines denotes the ground truth. FIG. 6A depicts an exemplary schematic of an estimated ionospheric coefficient (a0) from cUKF according to various disclosed embodiments of the present disclosure; FIG. 6B depicts an exemplary schematic of an estimated ionospheric coefficient (a1) from cUKF according to various disclosed embodiments of the present disclosure; and FIG. 6C depicts an exemplary schematic of an estimated ionospheric coefficient (a2) from cUKF according to various disclosed embodiments of the present disclosure. Referring to FIGS. 6A-6C, the tracking performance in terms of ionospheric coefficients of cUKF are illustrated. Exemplarily, referring to FIG. 6A, estimated ionospheric coefficient (a0) may be similar to the ground truth after around 380 s (time index).

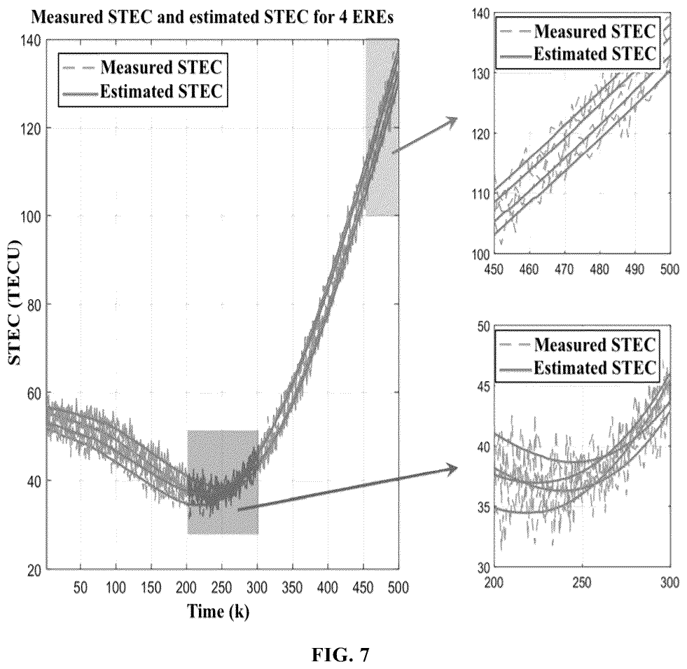

Measured TEC (STEC) and estimated TEC (STEC) for four EREs are shown in FIG. 7. FIG. 7 depicts an exemplary schematic of comparison of measured STEC and estimated STEC for four EREs according to various disclosed embodiments of the present disclosure. As shown in FIG. 7, the tracking performance in terms of STEC are illustrated. Referring to FIG. 7, for four EREs, estimated STECs may be similar to measured STECs after around 250 s (time index). The cUKF and EREs-SSG may estimate the locally optimal ionospheric coefficients (a0,a1 and a2) and then quickly and accurately estimate the ionospheric delays for potential EMI in the local region.

The locally optimized cUKF may be configured for refining the NeQuick-G model used in ionosphere estimation. The methodology may employ a single satellite and strategically positioned ground reference emitters, encompassing the estimated EMI location, to measure the ionosphere. In real-time, the UKF may continually update the ionospheric coefficients and fine-tune the coefficients specifically for the local area surrounding the EMI source. These precise coefficients may be then integrated into the NeQuick-G model to calculate the ionosphere along the path from the EMI source to the single satellite. Numerical results may affirm the efficacy of the methodology provided in the present disclosure, showcasing the synergy of cUKF-enabled NeQuick-G for ionosphere estimation and its subsequent impact on improving geolocation accuracy.

Various embodiments of the present disclosure provide an ionosphere estimation system. The system includes a memory, configured to store program instructions for performing an ionosphere estimation method applied to a single satellite; and a processor, coupled with the memory and, when executing the program instructions, configured for: providing locations of the single satellite and an enhanced reference emitter (ERE) of a plurality of EREs by the single satellite; using the locations of the single satellite and the ERE to obtain a measured ionospheric delay and transmitting the measured ionospheric delay to the ERE by the single satellite; determining a measured slant total electron content (STEC) using the measured ionospheric delay; and updating a NeQuick-G model deployed in one or more of the plurality of EREs by implementing a constrained unscented Kalman filter (cUKF). Updating the NeQuick-G model includes inputting a plurality of ionospheric coefficients estimated by cUKF to the NeQuick-G model; calculating an effective ionization level using the plurality of ionospheric coefficients; using the effective ionization level to obtain an estimated STEC; calculating updated ionospheric coefficients using the estimated STEC and the measured STEC; and updating the NeQuick-G model using the updated ionospheric coefficients. In one embodiment, the system may include the single satellite and a plurality of EREs.

Various embodiments of the present disclosure provide a non-transitory computer-readable storage medium, containing program instructions for, when being executed by a processor, performing an ionosphere estimation method applied to a single satellite. The method includes providing locations of the single satellite and an enhanced reference emitter (ERE) of a plurality of EREs by the single satellite; using the locations of the single satellite and the ERE to obtain a measured ionospheric delay and transmitting the measured ionospheric delay to the ERE by the single satellite; determining a measured slant total electron content (STEC) using the measured ionospheric delay; and updating a NeQuick-G model deployed in one or more of the plurality of EREs by implementing a constrained unscented Kalman filter (cUKF). Updating the NeQuick-G model includes inputting a plurality of ionospheric coefficients estimated by cUKF to the NeQuick-G model; calculating an effective ionization level using the plurality of ionospheric coefficients; using the effective ionization level to obtain an estimated STEC; calculating updated ionospheric coefficients using the estimated STEC and the measured STEC; and updating the NeQuick-G model using the updated ionospheric coefficients.

Although some embodiments of the present disclosure have been described in detail through various embodiments, those skilled in the art should understand that above embodiments may be for illustration only and may not be intended to limit the scope of the present disclosure. Those skilled in the art should understood that modifications may be made to above embodiments without departing from the scope and spirit of the present disclosure. The scope of the present disclosure may be defined by the appended claims.

What is claimed is:

1. An ionosphere estimation method applied to a single satellite, comprising:
providing locations of the single satellite and an enhanced reference emitter (ERE) of a plurality of EREs by the single satellite;
using the locations of the single satellite and the ERE to obtain a measured ionospheric delay and transmitting the measured ionospheric delay to the ERE by the single satellite;
determining a measured slant total electron content (STEC) using the measured ionospheric delay; and
updating a NeQuick-G model deployed in one or more of the plurality of EREs by implementing a constrained unscented Kalman filter (cUKF), wherein updating the NeQuick-G model includes:
inputting a plurality of ionospheric coefficients estimated by the cUKF to the NeQuick-G model;
calculating an effective ionization level using the plurality of ionospheric coefficients;
using the effective ionization level to obtain an estimated STEC;
calculating updated ionospheric coefficients using the estimated STEC and the measured STEC; and
updating the NeQuick-G model using the updated ionospheric coefficients.

2. The method according to claim 1, further comprising:
using the updated NeQuick-G model to estimate ionospheric delay along a path between the single satellite and an electromagnetic interference (EMI) source.

3. The method according to claim 1, wherein implementing the cUKF includes:
calculating sigma points in the cUKF using previous projected state estimates;
projecting a part of the sigma points which are not in a constrained solution space into a feasible region to obtain projected sigma points;
running the projected sigma points through time update equations to obtain time-projected sigma points and to obtain a time update;
projecting state estimates which are not in the constrained solution space into the feasible region to obtain projected state estimates; and
running the time-projected sigma points through measurement update equations to obtain a measurement update, wherein the measurement update includes the plurality of ionospheric coefficients.

4. The method according to claim 1, wherein determining the measured STEC using the measured ionospheric delay is defined as:
$$STEC = {I}_{f} / {α}_{f}$$
wherein I_{f} denotes the measured ionospheric delay, f denotes a frequency of an electromagnetic wave, and
$${α}_{f} = \frac{40 \text{.3} \times {10}^{16}}{{f}^{2}} .$$

5. The method according to claim 1, wherein:
a constraint of the cUKF is defined by the effective ionization level equal to or less than 400 solar flux units.

6. The method according to claim 1, wherein:
the plurality of ionospheric coefficients are constant during a tracking period.

7. A system, comprising:
a memory, configured to store program instructions for performing an ionosphere estimation method applied to a single satellite; and
a processor, coupled with the memory and, when executing the program instructions, configured for:
providing locations of the single satellite and an enhanced reference emitter (ERE) of a plurality of EREs by the single satellite;
using the locations of the single satellite and the ERE to obtain a measured ionospheric delay and transmitting the measured ionospheric delay to the ERE by the single satellite;
determining a measured slant total electron content (STEC) using the measured ionospheric delay; and
updating a NeQuick-G model deployed in one or more of the plurality of EREs by implementing a constrained unscented Kalman filter (cUKF), wherein updating the NeQuick-G model includes:
inputting a plurality of ionospheric coefficients estimated by the cUKF to the NeQuick-G model;
calculating an effective ionization level using the plurality of ionospheric coefficients;
using the effective ionization level to obtain an estimated STEC;
calculating updated ionospheric coefficients using the estimated STEC and the measured STEC; and
updating the NeQuick-G model using the updated ionospheric coefficients.

8. The system according to claim 7, wherein the processor is further configured for:
using the updated NeQuick-G model to estimate ionospheric delay along a path between the single satellite and an electromagnetic interference (EMI) source.

9. The system according to claim 7, wherein implementing the cUKF includes:
calculating sigma points in the cUKF using previous projected state estimates;
projecting a part of the sigma points which are not in a constrained solution space into a feasible region to obtain projected sigma points;
running the projected sigma points through time update equations to obtain time-projected sigma points and to obtain a time update;
projecting state estimates which are not in the constrained solution space into the feasible region to obtain projected state estimates; and
running the time-projected sigma points through measurement update equations to obtain a measurement update, wherein the measurement update includes the plurality of ionospheric coefficients.

10. The system according to claim 7, wherein determining the measured STEC using the measured ionospheric delay is defined as:
$$STEC = {I}_{f} / {α}_{f}$$
wherein I_{f} denotes the measured ionospheric delay, f denotes a frequency of an electromagnetic wave, and
$${α}_{f} = \frac{40 \text{.3} \times {10}^{16}}{{f}^{2}} .$$

11. The system according to claim 7, wherein:
a constraint of the cUKF is defined by the effective ionization level equal to or less than 400 solar flux units.

12. The system according to claim 7, wherein:
the plurality of ionospheric coefficients are constant during a tracking period.

13. A non-transitory computer-readable storage medium, containing program instructions for, when being executed by a processor, performing an ionosphere estimation method applied to a single satellite; the method comprising:
providing locations of the single satellite and an enhanced reference emitter (ERE) of a plurality of EREs by the single satellite;
using the locations of the single satellite and the ERE to obtain a measured ionospheric delay and transmitting the measured ionospheric delay to the ERE by the single satellite;
determining a measured slant total electron content (STEC) using the measured ionospheric delay; and
updating a NeQuick-G model deployed in one or more of the plurality of EREs by implementing a constrained unscented Kalman filter (cUKF), wherein updating the NeQuick-G model includes:
inputting a plurality of ionospheric coefficients estimated by the cUKF to the NeQuick-G model;
calculating an effective ionization level using the plurality of ionospheric coefficients;
using the effective ionization level to obtain an estimated STEC;
calculating updated ionospheric coefficients using the estimated STEC and the measured STEC; and
updating the NeQuick-G model using the updated ionospheric coefficients.

14. The storage medium according to claim 13, wherein the processor is further configured for:
using the updated NeQuick-G model to estimate ionospheric delay along a path between the single satellite and an electromagnetic interference (EMI) source.

15. The storage medium according to claim 13, wherein implementing the cUKF includes:
calculating sigma points in the cUKF using previous projected state estimates;
projecting a part of the sigma points which are not in a constrained solution space into a feasible region to obtain projected sigma points;
running the projected sigma points through time update equations to obtain time-projected sigma points and to obtain a time update;
projecting state estimates which are not in the constrained solution space into the feasible region to obtain projected state estimates; and
running the time-projected sigma points through measurement update equations to obtain a measurement update, wherein the measurement update includes the plurality of ionospheric coefficients.

16. The storage medium according to claim 13, wherein determining the measured STEC using the measured ionospheric delay is defined as:
$$STEC = {I}_{f} / {α}_{f}$$
wherein I_{f} denotes the measured ionospheric delay, f denotes a frequency of an electromagnetic wave, and
$${α}_{f} = \frac{40 \text{.3} \times {10}^{16}}{{f}^{2}} .$$

17. The storage medium according to claim 13, wherein:
a constraint of the cUKF is defined by the effective ionization level equal to or less than 400 solar flux units.

18. The storage medium according to claim 13, wherein:
the plurality of ionospheric coefficients are constant during a tracking period.
